(19) United States
(12) Patent Application Publication
(10) Pub. No.: US 2025/0096256 A1
(43) Pub. Date: Mar. 20, 2025

(54) THERMALLY STABLE NICKEL RICH CATHODES

(71) Applicant: GM GLOBAL TECHNOLOGY OPERATIONS LLC, DETROIT, MI (US)

(72) Inventors: Dewen Kong, Shanghai (CN); Meiyuan Wu, Shanghai (CN); Jingyuan Liu, Shanghai (CN); Haijing Liu, Shanghai (CN); Mark W. Verbrugge, Sonoma, CA (US)

(21) Appl. No.: 18/502,302

(22) Filed: Nov. 6, 2023

(30) Foreign Application Priority Data
Sep. 18, 2023 (CN) 202311204732.8

(51) Int. Cl. H01M 4/525; H01M 4/02; H01M 4/04; H01M 4/505; H01M 4/58; H01M 4/62

(52) U.S. Cl. CPC H01M 4/525; H01M 4/0404; H01M 4/0416; H01M 4/0435; H01M 4/505; H01M 4/5825; H01M 4/628; H01M 2004/021; H01M 2004/028; H01M 2220/20

(57) ABSTRACT

Aspects of the disclosure include systems and methods for manufacturing thermally stable nickel-rich cathodes. An exemplary method can include providing an active material including a plurality of active material particles. The plurality of active material particles include nickel. A nanoparticle slurry additive having a plurality of nanoparticles is provided. The plurality of nanoparticles include one or more of a thermally stable olivine type material, a thermally stable spinel type material, and a thermally stable manganese-nickel dioxide type material. The method includes forming a slurry by mixing the active material and the nanoparticle slurry additive. The plurality of nanoparticles form a thermal inhibitor layer on and in direct contact with a surface of the plurality of active material particles. A free-standing electrode film is formed by calendering the slurry and the free-standing electrode film is laminating to a current collector to define a thermally stable nickel-rich cathode.

### CROSS-REFERENCE TO RELATED PATENT APPLICATION

This application claims the benefit of Chinese Patent Application No. 202311204732.8, filed on Sep. 18, 2023, incorporated herein by reference in its entirety.

### INTRODUCTION

The subject disclosure relates to battery cell technologies, and particularly to thermally stable nickel-rich cathodes.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

The cathode (positive electrode) in a battery is one of the key components responsible for the electrochemical reactions that occur during charging and discharging processes. Modern automotive high voltage battery packs benefit from high energy density cathodes to improve overall performance and range. Nickle-rich cathodes, for example, have a higher theoretical specific capacity as compared to many other materials, such as iron and manganese-based cathodes. This means that nickel-rich cathodes can store more energy per unit mass, leading to higher energy density batteries.

### SUMMARY

In one exemplary embodiment a vehicle includes an electric motor and a battery pack electrically coupled to the electric motor. The battery pack includes an electrochemical cell. The electrochemical cell includes a cathode, an anode, and an electrolyte system between the cathode and the anode. The cathode includes an active material including a plurality of active material particles. The plurality of active material particles include nickel. The cathode further includes a thermal inhibitor layer formed on and in direct contact with a surface of each active material particle of the plurality of active material particles. The thermal inhibitor layer includes a plurality of nanoparticles. The plurality of nanoparticles include one or more of a thermally stable olivine type material, a thermally stable spinel type material, and a thermally stable manganese-nickel dioxide type material.

In addition to one or more of the features described herein, in some embodiments, the plurality of nanoparticles include a combination of two or more of the thermally stable olivine type material, the thermally stable spinel type material, and the thermally stable manganese-nickel dioxide type material.

In some embodiments, the thermally stable olivine type material includes one or more of lithium vanadyl phosphate, lithium manganese iron phosphate, cobalt phosphate, and lithium titanium phosphate.

In some embodiments, the thermally stable spinel type material includes one or more of lithium manganese oxide and lithium manganese nickel oxide.

In some embodiments, the thermally stable manganese-nickel dioxide type material includes one or more of lithium manganese dioxide and lithium manganese nickel dioxide.

In some embodiments, a mass ratio of the plurality of nanoparticles to the active material in the cathode is less than 30 percent.

In some embodiments, a surface coverage of the active material by the plurality of nanoparticles is 10 to 95 percent.

In another exemplary embodiment an electrochemical cell can include a cathode, an anode, and an electrolyte system between the cathode and the anode. The cathode includes an active material including a plurality of active material particles. The plurality of active material particles include nickel. The cathode further includes a thermal inhibitor layer formed on and in direct contact with a surface of each active material particle of the plurality of active material particles. The thermal inhibitor layer includes a plurality of nanoparticles. The plurality of nanoparticles include one or more of a thermally stable olivine type material, a thermally stable spinel type material, and a thermally stable manganese-nickel dioxide type material.

In yet another exemplary embodiment a method for manufacturing thermally stable nickel-rich cathodes includes providing an active material including a plurality of active material particles. The plurality of active material particles include nickel. A nanoparticle slurry additive having a plurality of nanoparticles is provided. The plurality of nanoparticles include one or more of a thermally stable olivine type material, a thermally stable spinel type material, and a thermally stable manganese-nickel dioxide type material. The method includes forming a slurry by mixing the active material and the nanoparticle slurry additive. The plurality of nanoparticles form a thermal inhibitor layer on and in direct contact with a surface of the plurality of active material particles. A free-standing electrode film is formed by calendering the slurry and the free-standing electrode film is laminating to a current collector to define a thermally stable nickel-rich cathode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle configured in accordance with one or more embodiments;

FIG. 2A is a simplified configuration of an electrochemical cell of a battery pack in accordance with one or more embodiments;

FIG. 2B is an example material matrix for a cathode of the electrochemical cell of FIG. 2A in accordance with one or more embodiments;

FIG. 3 is a process workflow of a slurry fabrication process for a thermally stable nickel-rich cathode in accordance with one or more embodiments;

FIG. 4 is a process workflow of a another slurry fabrication process for a thermally stable nickel-rich cathode in accordance with one or more embodiments;

FIG. 5 is a process workflow of yet another slurry fabrication process for a thermally stable nickel-rich cathode in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As discussed previously, modern automotive high voltage battery packs prefer high energy density materials, such as nickel-based cathodes, to improve energy density and charge/discharge efficiency. Unfortunately, nickel-rich cathodes such as NCMA (LiNiₓCo_{y}Mn_{z}Al_{1-x-y-z}O₂), NCA (LiNiₓCo_{y}Al_{1-x-y}O₂), and NMC811 (LiNiₓMn_{y}Co_{1-x-y}O₂) natively face challenges related to thermal stability. For example, these nickel-rich cathode materials decompose below 300 degrees Celsius to generate O₂, which can negatively react with cell components. In addition, high energy density of nickel-rich cathodes can lead to increased heat generation during elevated operating temperatures, such as when fast charging or high-rate discharging a battery. Thermal stability issues can result in battery degradation and reduced cycle life.

Introducing thermally stable materials such as lithium manganese iron phosphates (LMFP, LiMnₓFe₁₋ₓPO₄, where x is greater than or equal to 0.4) at mass ratios of 30 to 50 percent into the active material during cathode fabrication is known to enhance electrode thermal stability. A tradeoff, however, is that the high mass ratio of LMFP in the blended electrode can decrease energy density and reduce fast charge capabilities. Consequently, current cathodes and cathode manufacturing techniques must find a balance between thermal stability targets and energy density (battery performance).

This disclosure introduces fabrication processes for enhancing the thermal stability of nickel-rich cathodes while eliminating or mitigating the energy density tradeoff. Rather than incorporating bulk thermally stable materials (e.g., LMFP) directly into the active material, a nanoparticle slurry is introduced as an additive to construct a thermal inhibitor layer on a nickel-rich active material particle surface. The nanoparticle slurry includes a combination of two or three thermally stable material types: an olivine type, such as lithium vanadyl phosphate (LiVOPO₄), LMFP, cobalt phosphate (CoPO₄), lithium titanium phosphate (LiTi₂(PO₄)₃), a spinel type, such as LMO, LNMO, and a manganese-nickel dioxide type, such as lithium manganese dioxide (LiMnNiO₂) and lithium manganese nickel dioxide (LiMn_{0.7}Ni_{0.3}O₂). The thermally stable materials can be mixed with a solvent and/or can include a binder and a slurry stabilizing agent, such as Methyl cellulose. The resulting nano-sized thermal inhibitor layer protects the underlying active material from thermal effects.

Thermally stable nickel-rich cathodes fabricated in accordance with one or more embodiments offer several technical advantages over other nickel-rich cathodes. Notably, building nickel-rich cathodes from a slurry of nano-sized particle additives can reduce the blending ratio without sacrificing the thermal and electrochemical performance of the blended electrode. In other words, the mass ratio of the thermally stable nanoparticle additives can be lowered as compared to other processes without the loss of thermal stability and battery performance. In some embodiments, the nanoparticle mass ratio in the final electrode is only 1 to 30 percent, for example, 3 to 5 percent (or 5 to 20 percent, or 7 to 15 percent). For example, in some embodiments, the nanoparticle mass ratio in the final electrode is less than 20percent. In some embodiments, the nanoparticle mass ratio in the final electrode is less than 10 percent. In some embodiments, the nanoparticle mass ratio in the final electrode is less than 5 percent. Other advantages are possible. In particular, a pre-confected nano-additive slurry having a solids content of about 25 to about 45 percent can be easily integrated within an active material slurry directly at existing plant facilities, followed by robust mixing, coating, and pressing, without significantly overhauling existing equipment.

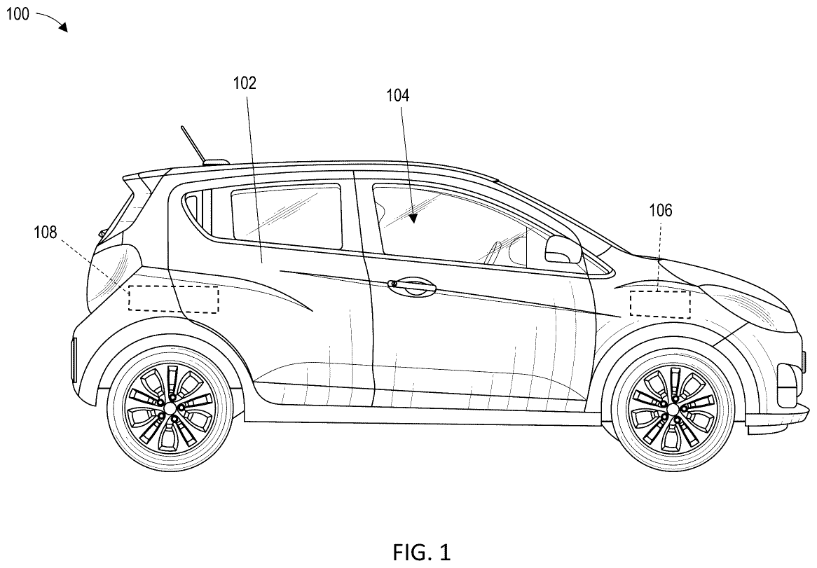

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

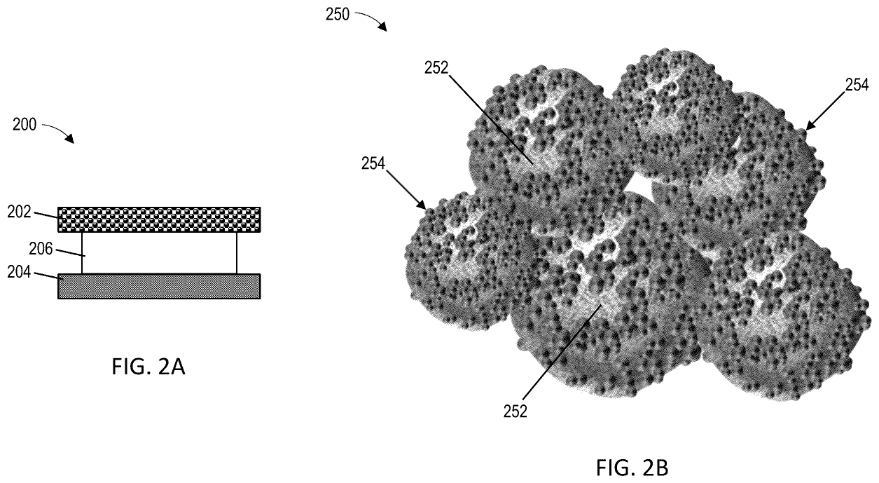

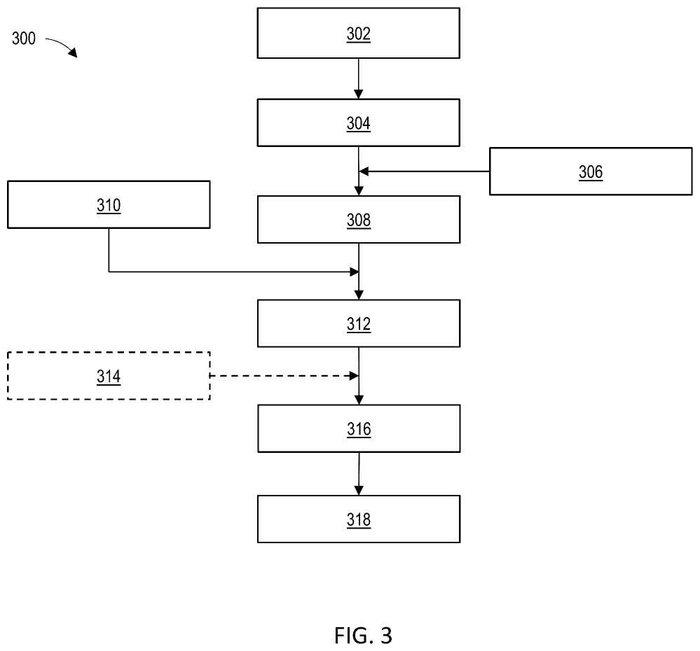

As discussed previously, in some embodiments, the battery pack 108 includes a thermally stable nickel-rich cathode (refer FIG. 2A). An example material matrix for thermally stable nickel-rich cathodes is discussed in greater detail with respect to FIG. 2B. Example fabrication processes for thermally stable nickel-rich cathodes are discussed in greater detail with respect to FIGS. 3, 4, and 5.

FIG. 2A illustrates a simplified configuration of an electrochemical cell of a battery pack (e.g., the battery pack 108 of FIG. 1) in accordance with one or more embodiments. As shown in FIG. 2A, an electrochemical cell 200 can include a cathode 202 (i.e., a positive electrode), an anode 204 (i.e., a negative electrode), and an electrolyte system 206 between the cathode 202 and the anode 204. While only a single electrochemical cell 200 is shown for convenience, it should be understood that a battery pack can contain any number of cells as needed to meet battery design constraints (e.g., capacity requirements).

In some embodiments, the cathode 202 is a thermally stable nickel-rich cathode having an active material coated with thermally stable nanoparticles. An example material matrix for the cathode 202 is discussed in greater detail with respect to FIG. 2B.

In some embodiments, the active material (also referred to as electroactive material) of the cathode 202 may include a lithium-based active material that can sufficiently undergo lithium intercalation and deintercalation, alloying and dealloying, and/or plating and stripping, while functioning as the positive terminal of the electrochemical cell 200. The cathode 202 electroactive materials may include one or more transition metals, such as manganese (Mn), nickel (Ni), cobalt (Co), chromium (Cr), iron (Fe), vanadium (V), and combinations thereof. In some embodiments, the cathode 202 includes one or both of lithium transition metal oxides with layered structure and lithium transition metal oxides with spinel phase. For example, in certain instances, the cathode 202 may include a spinel-type transition metal oxide, like lithium manganese oxide (Li₁₊ₓMn₂₋ₓO₄), where x is typically less than 0.15, including LiMn₂O₄ (LMO) and lithium manganese nickel oxide LiMn_{1.5}Ni_{0.5}O₄ (LNMO). In some embodiments, the cathode 202 can include layered materials like lithium cobalt oxide (LCO, LiCoO₂), lithium nickel oxide (LiNiO₂), a lithium nickel manganese cobalt oxide (LiNiₓMn_{y}Co_{z}O₂), including LiMn_{0.33}Ni_{0.33}Co_{0.33}O₂, a lithium nickel cobalt metal oxide (LiNi_{1-x-y}CoₓM_{y}O₂), where “M” can include Al, Mn, or the like, such as lithium nickel cobalt aluminum oxide (NCA, LiNiCoAlO₂), lithium nickel cobalt manganese oxide (NMC, LiNiCoMnO₂), and lithium nickel cobalt manganese aluminum oxide (NCMA, LiNiₓCo_{y}Mn_{z}Al_{1-x-y-2}O₂). Other known lithium-transition metal compounds such as lithium iron phosphate (LFP, LiFePO₄) or lithium iron fluorophosphate (Li₂FePO₄F) can also be used. In some embodiments, the cathode 202 can include an electroactive material that includes manganese, such lithium manganese oxide (Li₁₊ₓMn₂₋ₓO₄), a mixed lithium manganese nickel oxide (LiMn₂₋ₓNiₓO₄), and/or a lithium manganese nickel cobalt oxide (e.g., LiMn/3Ni/3Co/3O₂). In a lithium-sulfur battery, the cathode 202 can include elemental sulfur as the active material and/or a sulfur-containing active material.

In some embodiments, the electrolyte system 206 functions as a separator to provide a physical barrier between the cathode 202 and the anode 204. In some embodiments, the electrolyte system 206 includes a dendrite-blocking layer, one or more interface layers, and/or one or more electrolyte layers (not separately shown). In some embodiments, the electrolyte system 206, in addition to providing a physical barrier between the cathode 202 and the anode 204, can provide a minimal resistance path for the internal passage of lithium ions (and related anions) during cycling of the lithium ions to facilitate functioning of the electrochemical cell 200.

In some embodiments, the anode 204 includes an electroactive material such as a lithium host material capable of functioning as a negative terminal of the electrochemical cell 200. In various aspects, the electroactive material includes lithium and may be a lithium metal. In some embodiments, the anode 204 can include an electroactive lithium host material, such as graphite. In some embodiments, the anode 204 can include an electrically conductive material, as well as one or more polymeric binder materials to structurally hold the graphite material together. Negative electrodes may comprise greater than or equal to about 50% to less than or equal to about 100% of an electroactive material (e.g., graphite or graphite and lithiated silicon oxide blend), optionally less than or equal to about 30% of an electrically conductive material, and a balance binder. For example, in one embodiment, the anode 204 may include an active material including graphite particles intermingled with a binder material selected from the group consisting of: polyvinylidene difluoride (PVdF), ethylene propylene diene monomer (EPDM) rubber, and/or carboxymethoxyl cellulose (CMC), a styrene-butadiene rubber (SBR), a compound and/or mixture of CMC and SBR, a nitrile butadiene rubber (NBR), lithium polyacrylate (LiPAA), sodium polyacrylate (NaPAA), sodium alginate, lithium alginate, and combinations thereof, by way of non-limiting examples. Suitable additional electrically conductive materials may include carbon-based material and/or a conductive polymer. Carbon-based materials may include by way of non-limiting example, electrically-conductive carbon black, electrically-conductive acetylene black, acetylene black, carbon black, graphite, graphene, graphene oxides, carbon nanofibers, carbon nanotubes, and the like. Examples of a conductive polymer include polyaniline, polythiophene, polyacetylene, polypyrrole, and the like. In certain aspects, mixtures of these conductive materials may be used.

FIG. 2B illustrates an example material matrix 250 for the cathode 202 of FIG. 2A in accordance with one or more embodiments. As shown in FIG. 2B, the material matrix 250 can include an active material 252 and a plurality of nanoparticles 254. The active material 252 can be made of a range of suitable electroactive materials as discussed previously with respect to the cathode 202. For example, in some embodiments, the active material 252 includes NCMA, although other active materials are within the contemplated scope of this disclosure.

As further shown in FIG. 2B, in some embodiments, the plurality of nanoparticles 254 are bound to a surface of the active material 252. In some embodiments, the nanoparticles 254 are fixed to the surface of the active material 252 by introducing a nanoparticle slurry to a wet or dry active material solution. In some embodiments, the nanoparticles 254 are uniformly and/or randomly (as shown) distributed across the surface of the active material 252. Example fabrication processes for leveraging nanoparticle slurries to create thermally stable nickel-rich cathodes are discussed in greater detail with respect to FIGS. 3, 4, and 5.

In some embodiments, the nanoparticles 254 are thermally stable nanoparticles and the plurality of nanoparticles 254 together define, in aggregate, a thermal inhibitor layer for the active material 252. In some embodiments, the nanoparticles 254 include a thermally stable material type such as an olivine type, such as LiVOPO₄, LMFP, LFP, CoPO₄, LiTi₂(PO₄)₃, a spinel type, such as LMO, LNMO, and a manganese-nickel dioxide type, such as LiMnNiO₂, LiMn_{0.7}Ni_{0.3}O₂. In some embodiments, the nanoparticles 254 include a combination of two or three of the thermally stable material types.

In some embodiments, surface coverage of the active material 252 is about 15 to about 95 percent, for example, 15, 20, 25, 30, 35, 40, 45, 50, 55, 60, 65, 70, 75, 80, 85, 90, and 95 percent. In some embodiments, the mass ratio of the nanoparticles 254 in the final electrode (e.g., in the cathode 202) is only 1 to 30 percent, for example, 3 to 5 percent (or 5 to 20 percent, or 7 to 15 percent). For example, in some embodiments, the nanoparticle mass ratio in the final electrode is less than 20 percent. In some embodiments, the nanoparticle mass ratio in the final electrode is less than 10 percent. In some embodiments, the nanoparticle mass ratio in the final electrode is less than 5 percent.

In some embodiments, the matrix 250 includes a solvent, a binder, and/or a slurry stabilizing agent (not separately shown). Solvents can be selected from known materials depending on the choice in the active material 252. For example, the solvent for NCMA active materials can include N-Methyl-2-pyrrolidone (NMP). Other solvents, such as cyclic carbonates (e.g., ethylene carbonate (EC), propylene carbonate (PC), butylene carbonate (BC), fluoroethylene carbonate (FEC)); acyclic (i.e., linear) carbonates (e.g., dimethyl carbonate (DMC), diethyl carbonate (DEC), ethylmethylcarbonate (EMC)); aliphatic carboxylic esters (e.g., methyl formate, methyl acetate, methyl propionate); γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran, 1,3-dioxolane); and combinations thereof, are also possible.

The binder can be selected from a range of suitable materials, such as, for example, polyvinylidene fluoride polymer (PVDF). Other binder materials, such as polytetrafluoroethylene (PTFE), ethylene propylene diene monomer (EPDM) rubber, carboxymethoxyl cellulose (CMC), nitrile butadiene rubber (NBR), styrene ethylene butylene styrene copolymer (SEBS), styrene butylene styrene copolymer (SBS), lithium polyacrylate (LiPAA), sodium polyacrylate (NaPAA), sodium alginate, and lithium alginate, are possible. In some embodiments, the binder is incorporated at a weight ratio of 1 to 10 percent, for example, 3 percent, although other weight ratios are within the contemplated scope of this disclosure.

The slurry stabilizing agent can include materials such as methyl cellulose. In some embodiments, the stabilizing agent is incorporated at a weight ratio of 0.05 to 5 percent, for example, 0.5 percent, although other weight ratios are within the contemplated scope of this disclosure.

FIG. 3 illustrates a process workflow 300 of a slurry fabrication process for a thermally stable nickel-rich cathode in accordance with one or more embodiments. The workflow 300 can be carried out as part of forming a cathode (e.g., the cathode 202) of an electrochemical cell (e.g., the electrochemical cell 200). It should be understood that, while the process workflow 300 is largely discussed with respect to a single cell for convenience and ease of illustration, the underlying techniques can be repeated to produce cathodes for any number of cells in a battery pack.

The workflow 300 begins at block 302, where an active material, a binder material, and a conductive additive are sourced and/or otherwise prepared for mixing. In some embodiments, the active material can include a nickel-rich active material, such as, for example, NCMA, NCA, and/or NMC811. In some embodiments, the binder material can include one or more of PVDF, EPDM, CMC, SBR, NBR, LiPAA, NaPAA, sodium alginate, lithium alginate, and combinations thereof. In some embodiments, the binder material includes PVDF. In some embodiments, the conductive additive can include carbon black, acetylene black, enhanced carbon black (also referred to as Super P, or SP), graphite, graphene, graphene oxides, carbon nanofibers, carbon nanotubes, and the like. In some embodiments, the active material, the binder material, and the conductive additive are sourced as dry powders. In some embodiments, the active material, the binder material, and the conductive additive are sourced as dry powders having a solids content of 100 percent.

At block 304, the active material, the binder material, and the conductive additive undergo a dry powder mixing process. In some embodiments, the active material, the binder material, and the conductive additive are dry mixed using a planetary mixer having a low speed of between 10 and 50 revolutions per minute (RPM) for 30 minutes, for example 20 RPM, and a high speed of between 0 and 1000 RPM, for example 0 RPM. In some embodiments, dry mixing occurs at a temperature of about 25 degrees Celsius, although other temperatures are within the contemplated scope of this disclosure.

At block 306, a solvent is mixed into the dry powder mixture of the active material, the binder material, and the conductive additive to define an active material slurry. In some embodiments, the solvent includes NMP. In some embodiments, the solvent is added to target a solids content between 100 percent and 70 percent, for example 76 percent, in the active material slurry.

At block 308, the active material slurry is folded, stirred, and/or otherwise agitated to ensure uniform wetting of the particles. This process can be referred to as kneading. In some embodiments, the active material slurry is continuously mixed and kneaded using mechanical agitation and/or other mixing techniques to achieve a consistent and well-dispersed slurry. Kneading ensures that the active material particles are uniformly coated with the solvent, forming a paste-like consistency. In some embodiments, the mixing and kneading (blocks 304 and 306) occur substantially simultaneously, where solvent is slowly and incrementally added to the base dry powder until the solids are fully wetted, providing a homogeneous paste or “slurry”. In some embodiments, kneading using a planetary mixer having a low speed of between 1 and 100 RPM for 40 minutes, for example 40 RPM, and a high speed of between 100 and 1000 RPM, for example 500 RPM. In some embodiments, kneading occurs at a temperature of about 25 degrees Celsius, although other temperatures are within the contemplated scope of this disclosure. In some embodiments, kneading continues until a solids content of about 76 percent.

At block 310, a nanoparticle slurry additive is sourced and/or otherwise prepared for mixing with the active material paste/slurry. In some embodiments, the nanoparticle slurry additive includes a plurality of nanoparticles. In some embodiments, the nanoparticles include thermally stable material types such as an olivine type, such as LiVOPO₄, LMFP, CoPO₄, LiTi₂(PO₄)₃, a spinel type, such as LMO, LNMO, and a manganese-nickel dioxide type, such as LiMnNiO₂, LiMn_{0.7}Ni_{0.3}O₂. In some embodiments, the nanoparticles include a combination of two or three of the thermally stable material types. In some embodiments, the nanoparticle slurry additive is itself a mixed combination of dry powder nanoparticles and a solvent, such as NMP, to ensure flowability. In some embodiments, a mass ratio of nanoparticles in the nanoparticle slurry additive is about 20 to about 50 percent, for example, 25 to 40 percent. In some embodiments, a viscosity of the nanoparticle slurry additive is less than 8000 millipascal-second (mPa-s).

In some embodiments, the nanoparticle slurry additive includes 35 weight percent LMFP nanoparticles, 3 weight percent methoxyl cellulose (MC), and 62 weight percent NMP.

At block 312, the nanoparticle slurry additive from block 310 is mixed with the active material paste/slurry from block 308 to define a coated active material slurry (also referred to as a nano-wrapped active material particle slurry). In some embodiments, the nanoparticle slurry additive and the active material paste/slurry are mixed using a planetary mixer having a low speed of between 10 and 100 revolutions per minute (RPM), for example 60 RPM, and a high speed of between 1000 and 4000 RPM, for example 2000 RPM. In some embodiments, mixing occurs for one hour. In some embodiments, mixing occurs for 10 minutes, 30 minutes, 1 hour, 2, hours, 4, hours, 8, hours, 12, hours, or 24 hours. In some embodiments, mixing continues until a solids content of about 72 percent.

In some embodiments, a mass ratio of nanoparticles in the resulting coated active material slurry is only 1 to 30 percent, as discussed previously. For example, the mass ratio of nanoparticles in the coated active material slurry can be 3 to 5 percent, 5 to 20 percent, 7 to 15 percent, etc. In some embodiments, the nanoparticle mass ratio in the coated active material slurry is less than 20 percent. In some embodiments, the nanoparticle mass ratio in the coated active material slurry is less than 10 percent. In some embodiments, the nanoparticle mass ratio in the coated active material slurry is less than 5 percent.

Optionally, at block 314, additional solvent is mixed into the coated active material slurry from block 312 to further fine tune the solids content. In some embodiments, the additional solvent includes NMP. In some embodiments, the additional solvent is added to target a solids content of about 30 to 75 percent, for example 69 percent.

At block 316, the optional additional solvent from block 314 is added to the coated active material slurry from block 312 to define a final slurry. In some embodiments, the final slurry can be formed using a planetary mixer having a low speed of between 10 and 50 revolutions per minute (RPM), for example 40 RPM, and a high speed of between 1000 and 4000 RPM, for example 3000 RPM. In some embodiments, mixing occurs for 40 minutes. In some embodiments, mixing occurs for 10 minutes, 30 minutes, 1 hour, 2, hours, 4, hours, 8, hours, 12, hours, or 24 hours.

At block 318, the final slurry from block 316 undergoes coating and/or calendering to form a free-standing electrode film. In some embodiments, the final slurry is pressed in a calendering machine and the resultant free-standing electrode film is laminated to a current collector to define a thermal stability enhanced nickel-rich cathode.

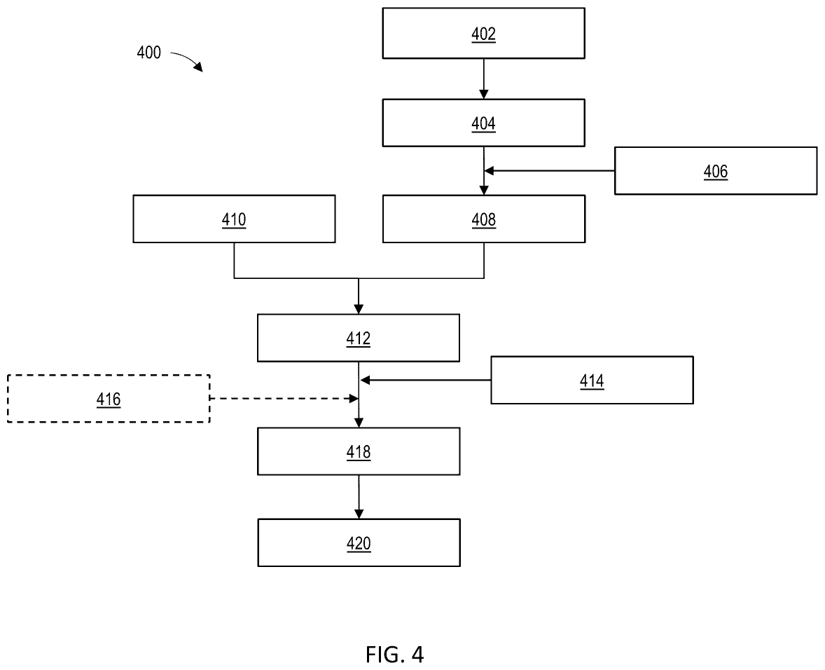

FIG. 4 illustrates a process workflow 400 of another slurry fabrication process for a thermally stable nickel-rich cathode in accordance with one or more embodiments. The workflow 400 can be carried out as part of forming a cathode (e.g., the cathode 202) of an electrochemical cell (e.g., the electrochemical cell 200). It should be understood that, while the process workflow 400 is largely discussed with respect to a single cell for convenience and ease of illustration, the underlying techniques can be repeated to produce cathodes for any number of cells in a battery pack.

The workflow 400 begins at block 402, where a binder material and a solvent are sourced and/or otherwise prepared for mixing. In some embodiments, the binder material can include one or more of PVDF, EPDM, CMC, NBR, LiPAA, NaPAA, sodium alginate, lithium alginate, and combinations thereof. In some embodiments, the binder material includes PVDF. In some embodiments, the solvent includes NMP.

In some embodiments, the binder material and the solvent are pre-mixed at a temperature of 25 to 55 degrees Celsius. In some embodiments, the binder material and the solvent are mixed using a planetary mixer having a low speed of between 10 and 100 RPM, for example 20 RPM, and a high speed of between 100 and 1000 RPM, for example 400 RPM. In some embodiments, mixing occurs for 100 minutes. In some embodiments, mixing occurs for 10 minutes, 30 minutes, 1 hour, 2, hours, 4, hours, 8, hours, 12, hours, or 24 hours. In some embodiments, the mixed binder material and solvent include a solids content of 5 to 15 percent, for example 8 percent.

At block 404, the binder material and solvent are mixed to define a solution. In some embodiments, solvent is added to the solution to fully wet the binder material, which can be sourced as a dry powder.

At block 406, a conductive additive is added to the solution from block 404. In some embodiments, the conductive additive can include carbon black, acetylene black, enhanced carbon black (also referred to as Super P, or SP), graphite, graphene, graphene oxides, carbon nanofibers, carbon nanotubes, and the like. In some embodiments, the conductive additive is incorporated at a temperature of 25 degrees Celsius. In some embodiments, the conductive additive is incorporated using a planetary mixer having a low speed of between 10 and 100 RPM, for example 40 RPM, and a high speed of between 1000 and 4000 RPM, for example 2000 RPM. In some embodiments, mixing occurs for 30 minutes. In some embodiments, mixing occurs for 10 minutes, 30 minutes, 1 hour, 2, hours, 4, hours, 8, hours, 12, hours, or 24 hours. In some embodiments, the solids content after adding the conductive additive is 7 to 20 percent, for example 12 percent.

At block 408, the solution and conductive additive are mixed to define a first slurry. In some embodiments, the solution and conductive additive are mixed using a planetary mixer having a low speed of between 10 and 50 revolutions per minute (RPM), for example 40 RPM, and a high speed of between 1000 and 4000 RPM, for example 2000 RPM.

At block 410, a nanoparticle slurry additive is sourced and/or otherwise prepared for mixing with the first slurry from block 408. In some embodiments, the nanoparticle slurry additive includes a plurality of nanoparticles. In some embodiments, the nanoparticles include thermally stable material types such as an olivine type, such as LiVOPO₄, LMFP, CoPO₄, LiTi₂(PO₄)₃, a spinel type, such as LMO, LNMO, and a manganese-nickel dioxide type, such as LiMnNiO₂, LiMn_{0.7}Ni_{0.3}O₂. In some embodiments, the nanoparticles include a combination of two or three of the thermally stable material types. In some embodiments, the nanoparticle slurry additive is itself a mixed combination of dry powder nanoparticles and a solvent, such as NMP, to ensure flowability.

In some embodiments, the nanoparticle slurry additive includes 35weight percent LMFP nanoparticles, 3 weight percent methoxyl cellulose (MC), and 62 weight percent NMP.

In some embodiments, a mass ratio of nanoparticles in the nanoparticle slurry additive is about 20 to about 50 percent, for example, 35 to 45 percent. In some embodiments, a viscosity of the nanoparticle slurry additive is less than 8000 millipascal-second (mPa-s).

At block 412, the nanoparticle slurry additive is mixed with the first slurry to define a second slurry. In some embodiments, the second slurry can be formed using a planetary mixer having a low speed of between 10 and 50 RPM, for example 40 RPM, and a high speed of between 1000 and 4000 RPM, for example 2000 RPM. In some embodiments, mixing occurs for 30 minutes. In some embodiments, mixing occurs for 10 minutes, 30 minutes, 1 hour, 2, hours, 4, hours, 8, hours, 12, hours, or 24 hours. In some embodiments, mixing occurs at a temperature of 25 Celsius.

At block 414, an active material is added to the second slurry from block 412. In some embodiments, the active material can include a nickel-rich active material, such as, for example, NCMA, NCA, and/or NMC811.

Optionally, at block 416, additional solvent is added to the second slurry to further fine tune the solids content. In some embodiments, the additional solvent includes NMP. In some embodiments, the additional solvent is added to target a solids content of about 50 to 80 percent, for example 72 percent.

At block 418, the active material from block 414, the optional additional solvent from block 416, and the second slurry from block 412 are mixed to define a third slurry. In some embodiments, the third slurry can be formed using a planetary mixer having a low speed of between 10 and 50 revolutions per minute (RPM), for example 40 RPM, and a high speed of between 1000 and 4000 RPM, for example 3000 RPM. In some embodiments, mixing occurs for 100 minutes. In some embodiments, mixing occurs for 10 minutes, 30 minutes, 1 hour, 2, hours, 4, hours, 8, hours, 12, hours, or 24 hours. In some embodiments, the resultant mixture includes a solids content of 50 to 80 percent, for example, 69 percent. In some embodiments, mixing occurs at a temperature of 25 Celsius.

At block 420, the third slurry from block 418 undergoes coating and/or calendering to form a free-standing electrode film. In some embodiments, the third slurry is pressed in a calendering machine and the resultant free-standing electrode film is laminated to a current collector to define a thermal stability enhanced nickel-rich cathode.

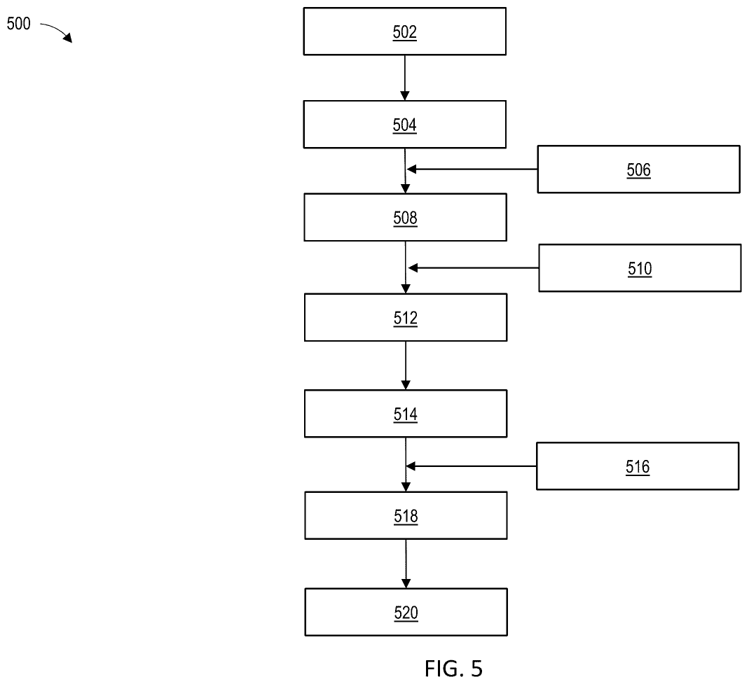

FIG. 5 illustrates a process workflow 500 of yet another slurry fabrication process for a thermally stable nickel-rich cathode in accordance with one or more embodiments. The workflow 500 can be carried out as part of forming a cathode (e.g., the cathode 202) of an electrochemical cell (e.g., the electrochemical cell 200). It should be understood that, while the process workflow 500 is largely discussed with respect to a single cell for convenience and ease of illustration, the underlying techniques can be repeated to produce cathodes for any number of cells in a battery pack.

The workflow 500 begins at block 502, where a slurry stabilizing agent and a solvent are sourced and/or otherwise prepared for mixing. In some embodiments, the slurry stabilizing agent can include methyl cellulose, although other stabilizers are within the contemplated scope of this disclosure. In some embodiments, the solvent includes NMP.

At block 504, the slurry stabilizing agent and solvent are mixed to define a solution. In some embodiments, the slurry stabilizing agent and solvent are mixed with an active material. In some embodiments, the active material can include a nickel-rich active material, such as, for example, NCMA, NCA, and/or NMC811.

In some embodiments, solvent is added to the solution to fully wet the slurry stabilizing agent and/or the active material. In some embodiments, the slurry stabilizing agent, the solvent, and the active material are mixed using a planetary mixer having a low speed of between 10 and 50 revolutions per minute (RPM), for example 20 RPM, and a high speed of between 1000 and 4000 RPM, for example 2000 RPM. In some embodiments, mixing occurs for one hour. In some embodiments, a solids content of the solution is between 8 and 12 percent.

At block 506, a nanoparticle slurry additive is sourced and/or otherwise prepared for mixing with the solution from block 504. In some embodiments, the nanoparticle slurry additive includes a plurality of nanoparticles. In some embodiments, the nanoparticles include thermally stable material types such as an olivine type, such as LiVOPO₄, LMFP, CoPO₄, LiTi₂(PO₄)₃, a spinel type, such as LMO, LNMO, and a manganese-nickel dioxide type, such as LiMnNiO₂, LiMn_{0.7}Ni_{0.3}O₂. In some embodiments, the nanoparticles include a combination of two or three of the thermally stable material types. In some embodiments, the nanoparticle slurry additive is itself a mixed combination of dry powder nanoparticles and a solvent, such as NMP, to ensure flowability.

At block 508, the nanoparticle slurry additive (with or without solvent) from block 506 and the solution from block 504 are mixed to define a first slurry. In some embodiments, the first slurry is mixed using a planetary mixer having a low speed of between 10 and 50 revolutions per minute (RPM), for example 30 RPM, and a high speed of between 1000 and 4000 RPM, for example 2000 RPM. In some embodiments, mixing occurs for one hour. In some embodiments, a solids content of the first slurry is between 45 and 55 percent, for example, 50 percent.

In some embodiments, the nanoparticle slurry additive in the first slurry coats the active material. In some embodiments, the nanoparticle slurry additive is LMFP and the first slurry includes LMFP wrapped (coated) active material (e.g., NCMA).

At block 510, a solvent is mixed into the first slurry from block 508 to define, at block 512, a second slurry. In some embodiments, the solvent includes NMP. In some embodiments, the solvent is added to target a solids content of 30 to 50 percent, for example 40 percent, in the second slurry. In some embodiments, the second slurry is mixed using a planetary mixer having a low speed of between 10 and 50 revolutions per minute (RPM), for example 30 RPM, and a high speed of between 1000 and 4000 RPM, for example 3000 RPM. In some embodiments, mixing occurs for half an hour.

At block 514, the second slurry from block 512 is degassed. In some embodiments, degassing occurs in vacuum. In some embodiments, degassing occurs for half an hour. In some embodiments, degassing occurs for at least half an hour, for example, 1 hour, 2 hours, 4 hours, etc. In some embodiments, a solids content of the second slurry after degassing is between 30 and 50 percent, for example, 40 percent.

At block 516, a binder, a conductive additive, and/or processing solvents are mixed with the second slurry from block 514. In some embodiments, the binder material can include one or more of PVDF, EPDM, CMC, NBR, LiPAA, NaPAA, sodium alginate, lithium alginate, and combinations thereof. In some embodiments, the binder material includes PTFE. In some embodiments, the binder is incorporated at a weight ratio of 1 to 5 percent, for example, 3 percent, although other weight ratios are within the contemplated scope of this disclosure. In some embodiments, the conductive additive can include carbon black, acetylene black, enhanced carbon black (also referred to as Super P, or SP), graphite, graphene, graphene oxides, carbon nanofibers, carbon nanotubes, and the like. In some embodiments, the processing solvents can include NMP.

At block 518, the mixture from block 516 undergoes coating and/or calendering to form a free-standing electrode film. In some embodiments, the mixture is pressed in a calendering machine to define the resultant free-standing electrode film. At block 520, the free-standing electrode film from block 518 is laminated to a current collector to define a thermal stability enhanced nickel-rich cathode.

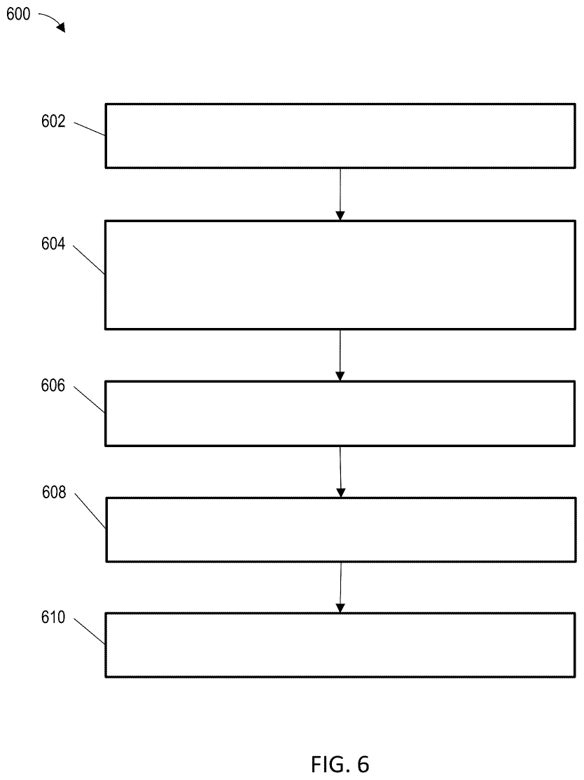

Referring now to FIG. 6, a flowchart 600 for manufacturing thermally stable nickel-rich cathodes is generally shown according to an embodiment. Although depicted in a particular order, the blocks depicted in FIG. 6 can be rearranged, subdivided, and/or combined.

At block 602, the method includes providing an active material including a plurality of active material particles. In some embodiments, the plurality of active material particles include nickel. In some embodiments, the active material can include a nickel-rich active material, such as, for example, NCMA, NCA, and/or NMC811.

At block 604, the method includes providing a nanoparticle slurry additive including a plurality of nanoparticles. In some embodiments, the plurality of nanoparticles include one or more of a thermally stable olivine type material, a thermally stable spinel type material, and a thermally stable manganese-nickel dioxide type material.

In some embodiments, the plurality of nanoparticles include a combination of two or more of the thermally stable olivine type material, the thermally stable spinel type material, and the thermally stable manganese-nickel dioxide type material.

In some embodiments, the thermally stable olivine type material includes one or more of lithium vanadyl phosphate, lithium manganese iron phosphate, cobalt phosphate, and lithium titanium phosphate. In some embodiments, the thermally stable spinel type material includes one or more of lithium manganese oxide and lithium manganese nickel oxide. In some embodiments, the thermally stable manganese-nickel dioxide type material includes one or more of lithium manganese dioxide and lithium manganese nickel dioxide.

At block 606, the method includes forming a slurry by mixing the active material and the nanoparticle slurry additive. In some embodiments, the plurality of nanoparticles form a thermal inhibitor layer on and in direct contact with a surface of the plurality of active material particles.

At block 608, the method includes forming a free-standing electrode film by hot rolling/calendering the slurry and/or the dry powder mixture.

At block 610, the method includes laminating the free-standing electrode film to a current collector to define a thermally stable nickel-rich cathode.

In some embodiments, a mass ratio of the plurality of nanoparticles to the active material in the cathode comprises less than 20 percent. In some embodiments, a surface coverage of the active material by the plurality of nanoparticles comprises 15 to 95 percent.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising an electrochemical cell, the electrochemical cell comprising:
a cathode;
an anode; and
an electrolyte system between the cathode and the anode;
wherein the cathode comprises:
an active material comprising a plurality of active material particles, the plurality of active material particles comprising nickel; and
a thermal inhibitor layer formed on and in direct contact with a surface of each active material particle of the plurality of active material particles, the thermal inhibitor layer comprising a plurality of nanoparticles, the plurality of nanoparticles comprising one or more of a thermally stable olivine type material, a thermally stable spinel type material, and a thermally stable manganese-nickel dioxide type material.

2. The vehicle of claim 1, wherein the plurality of nanoparticles comprise a combination of two or more of the thermally stable olivine type material, the thermally stable spinel type material, and the thermally stable manganese-nickel dioxide type material.

3. The vehicle of claim 1, wherein the thermally stable olivine type material comprises one or more of lithium vanadyl phosphate, lithium manganese iron phosphate, cobalt phosphate, and lithium titanium phosphate.

4. The vehicle of claim 1, wherein the thermally stable spinel type material comprises one or more of lithium manganese oxide and lithium manganese nickel oxide.

5. The vehicle of claim 1, wherein the thermally stable manganese-nickel dioxide type material comprises one or more of lithium manganese dioxide and lithium manganese nickel dioxide.

6. The vehicle of claim 1, wherein a mass ratio of the plurality of nanoparticles to the active material in the cathode comprises less than 30 percent.

7. The vehicle of claim 1, wherein a surface coverage of the active material by the plurality of nanoparticles comprises 10 to 95 percent.

8. An electrochemical cell comprising:
a cathode;
an anode; and
an electrolyte system between the cathode and the anode;
wherein the cathode comprises:
an active material comprising a plurality of active material particles, the plurality of active material particles comprising nickel; and
a thermal inhibitor layer formed on and in direct contact with a surface of each active material particle of the plurality of active material particles, the thermal inhibitor layer comprising a plurality of nanoparticles, the plurality of nanoparticles comprising one or more of a thermally stable olivine type material, a thermally stable spinel type material, and a thermally stable manganese-nickel dioxide type material.

9. The electrochemical cell of claim 8, wherein the plurality of nanoparticles comprise a combination of two or more of the thermally stable olivine type material, the thermally stable spinel type material, and the thermally stable manganese-nickel dioxide type material.

10. The electrochemical cell of claim 8, wherein the thermally stable olivine type material comprises one or more of lithium vanadyl phosphate, lithium manganese iron phosphate, cobalt phosphate, and lithium titanium phosphate.

11. The electrochemical cell of claim 8, wherein the thermally stable spinel type material comprises one or more of lithium manganese oxide and lithium manganese nickel oxide.

12. The electrochemical cell of claim 8, wherein the thermally stable manganese-nickel dioxide type material comprises one or more of lithium manganese dioxide and lithium manganese nickel dioxide.

13. The electrochemical cell of claim 8, wherein a mass ratio of the plurality of nanoparticles to the active material in the cathode comprises less than 30 percent.

14. The electrochemical cell of claim 8, wherein a surface coverage of the active material by the plurality of nanoparticles comprises 10 to 95 percent.

15. A method for manufacturing thermally stable nickel-rich cathodes, the method comprising:
providing an active material comprising a plurality of active material particles, the plurality of active material particles comprising nickel;
providing a nanoparticle slurry additive comprising a plurality of nanoparticles, the plurality of nanoparticles comprising one or more of a thermally stable olivine type material, a thermally stable spinel type material, and a thermally stable manganese-nickel dioxide type material;
forming a slurry by mixing the active material and the nanoparticle slurry additive, wherein the plurality of nanoparticles form a thermal inhibitor layer on and in direct contact with a surface of the plurality of active material particles;
forming a free-standing electrode film by calendering the slurry; and
laminating the free-standing electrode film to a current collector to define a thermally stable nickel-rich cathode.

16. The method of claim 15, wherein the plurality of nanoparticles comprise a combination of two or more of the thermally stable olivine type material, the thermally stable spinel type material, and the thermally stable manganese-nickel dioxide type material.

17. The method of claim 15, wherein the thermally stable olivine type material comprises one or more of lithium vanadyl phosphate, lithium manganese iron phosphate, cobalt phosphate, and lithium titanium phosphate.

18. The method of claim 15, wherein the thermally stable spinel type material comprises one or more of lithium manganese oxide and lithium manganese nickel oxide.

19. The method of claim 15, wherein the thermally stable manganese-nickel dioxide type material comprises one or more of lithium manganese dioxide and lithium manganese nickel dioxide.

20. The method of claim 15, wherein a mass ratio of the plurality of nanoparticles to the active material in the thermally stable nickel-rich cathode comprises less than 20 percent.
